(19) United States
(12) Patent Application Publication
(10) Pub. No.: US 2008/0174364 A1
(43) Pub. Date: Jul. 24, 2008

(54) INTERNAL SUPPLY-VOLTAGE GENERATOR OF SEMICONDUCTOR MEMORY DEVICE

(76) Inventor: Doo-young Kim, Seongnam-si (KR)

Correspondence Address: F. CHAU & ASSOCIATES, LLC, 130 WOODBURY ROAD, WOODBURY, NY, 11797, US

(21) Appl. No.: 11/971,275

(22) Filed: Jan. 9, 2008

(30) Foreign Application Priority Data
Jan. 10, 2007 (KR) 10-2007-0003077

(51) Int. Cl. G05F 1/46; G05F 1/10

(52) U.S. Cl. 327/541

(57) ABSTRACT

An internal supply-voltage generator of a semiconductor memory device, which can be used both in a high-voltage test mode and in a normal operation mode, maintains a constant response speed in the normal operation mode and includes; a comparator comparing a reference voltage with an internal supply voltage and outputting the result of the comparison through an output terminal; and a driver receiving an external supply voltage and outputting the internal supply voltage in response to the result of the comparisons wherein the internal supply voltage is directly fed back to the comparator, and the output terminal of the comparator is electrically disconnected from an operating voltage source of the comparator when the semiconductor memory device is in a high-voltage test mode.

### CROSS-REFERENCE TO RELATED PATENT APPLICATION

This application claims the benefit of Korean Patent Application No. 10-2007-0003077, filed on Jan. 10, 2007, in the Korean lntellectual Property Office, the disclosure of which is incorporated herein in its entirety by reference.

### BACKGROUND OF THE INVENTION

1. Technical Field

The present disclosure relates to a semiconductor memory device and, more particularly, to an internal supply voltage generator of a semiconductor memory device.

2. Discussion of Related Art

In a semiconductor memory device, specifically, in a Dynamic Random Access Memory (DRAM), as the degree of integration increases, the thicknesses of the gate oxide films become thinner and thinner. Accordingly, the resisting pressure of the gate oxide film of a transistor is lowered, which deteriorates the reliability of the semiconductor memory device. For this reason, in order to ensure the reliability of such a semiconductor memory device and to reduce power consumption, a low external supply voltage is used. From a semiconductor memory users' viewpoint, however, that is, from the system makers' viewpoint, lowering an external supply voltage is not preferable because it increases manufacturing costs, and the like.

Accordingly, in an attempt to solve this problem, an internal supply voltage generating method has been developed. In the internal supply voltage generating method, when an external supply voltage from the outside is supplied to a chip, an internal supply-voltage generator clamps the external supply voltage and generates an internal supply voltage lower than the external supply voltage and supplies the internal supply voltage inside the chip. A conventional internal supply-voltage generating circuit is disclosed in U.S. Pat. No. 5,808,953.

FIG. 1 is a circuit diagram of a conventional internal supply-voltage generator.

Referring to FIG. 1 the conventional internal supply-voltage generator includes a comparator 11 for comparing a reference voltage VREF with an internal supply voltage IVC and outputting the result CO of the comparison through an output terminal, and a driver 13 for receiving an external supply voltage EVC and outputting the internal supply voltage IVC in response to the result CO of the comparison.

Generally, semiconductor makers perform a high-voltage test for operating a semiconductor memory device at a supply voltage higher than a voltage at which the semiconductor memory device operates in a normal state, in order to test the reliability of the semiconductor memory device. For example in a high-voltage test mode, in order to raise an internal supply voltage IVC to an external supply voltage EVC, a method of raising a reference voltage VREF to the external supply voltage EVC without varying the operation of the comparator 11 can be used.

In this case, however, due to the voltage drop of the driver 13, it is difficult to make the internal supply voltage IVC be substantially equal to the external supply voltage EVC. Also, due to an increase in operation current of the comparator 11, when the operating current exceeds a current rating of the tester, the high-voltage test cannot be performed.

Accordingly, an internal supply-voltage generator that can be used both when a semiconductor memory device operates in a normal operation mode and when the semiconductor memory device operates in a high-voltage test mode, is employed. FIG. 2 is a circuit diagram of a conventional internal supply-voltage generator that can be used both in a normal operation mode and in a high-voltage test mode.

Referring to FIG. 2, the conventional internal supply-voltage generator includes a comparator 21, a driver MP20, and control transistors MP21 and MN23 and logic gates NR21, I21, and OR21 for controlling a high-voltage test. The comparator 21 includes PMOS transistors MP22 through MP25, and NMOS transistors MN20 through MN22. The transistors are connected between an external supply voltage EVC and a ground voltage VSS.

When a semiconductor memory device operates in the high-voltage test mode, a high-voltage test control signal HVCC_TEST is logic “high”, and an internal supply-voltage generator enable signal ENABLE is logic “low”. Accordingly. the control transistor MP21, which is a PMOS transistor, is turned off, and the control transistor MN23, which is a NMOS transistor, is turned on. Accordingly, in the high-voltage test mode, the internal supply voltage IVC is not fed back to the comparator 21, and the NMOS transistor MN21 of the comparator 21 is turned off.

When the semiconductor memory device operates in the normal operation mode, the high-voltage test signal HVCC_TEST is logic “low”, and the internal supply-voltage generator enable signal ENABLE is logic “high”. Accordingly, the PMOS control transistor MP21 is turned on, and the NMOS control transistor MN23 is turned off. Accordingly, the internal supply voltage IVC is fed back to the comparator 21 through the PMOS control transistor MP21, and the comparator 21 operates normally.

The internal supply-voltage generator illustrated in FIG. 2 has a disadvantage that a response speed is slow, because the internal supply voltage IVC is fed back to the comparator 21 through the PMOS control transistor MP21 in the normal operation mode.

### SUMMARY OF THE INVENTION

Exemplary embodiments of the present invention provide an internal supply-voltage generator that can be used both in a high-voltage test mode and in a normal operation mode, and maintain a constant response speed in the normal operation mode.

According to an exemplary embodiment of the present invention, there is provided an internal supply-voltage generator of a semiconductor memory device including: a comparator comparing a reference voltage with an internal supply voltage and outputting the result of the comparison through an output terminal; and a driver receiving an external supply voltage and outputting the internal supply voltage in response to the result of the comparison, wherein the internal supply voltage is directly fed back to the comparator, and the output terminal of the comparator is electrically disconnected from an operating voltage source of the comparator when the semiconductor memory device is in a high-voltage test mode.

The comparator includes: a first input transistor having one end connected to the output terminal, and a gate to which the reference voltage is applied; a second input transistor having one end connected to a complementary output terminal of the output terminal, and a gate to which the internal supply voltage is applied; and a control transistor connected between the other end of the first input transistor and the other end of the second input transistor, wherein, when the semiconductor memory device is in a normal operation mode, the control transistor is turned on so that the comparator operates normally, and, when the semiconductor memory device is in the high-voltage test mode, the control transistor is turned off so that the output terminal is electrically disconnected from the operating voltage source of the comparator.

The comparator includes: a first input transistor having one end connected to the output terminal, and the other end connected to a common node; and a second input transistor having one end connected to the complementary output terminal of the output terminal, a gate to which the internal supply voltage is applied, and the other end connected to the common node, wherein, when the semiconductor memory device is in the normal operation mode, the reference voltage is applied to the gate of the first input transistor so that the comparator operates normally, and, when the semiconductor memory device is in the high voltage test mode, the first input transistor is turned off so that the output terminal is electrically disconnected from the operating voltage source of the comparator.

### BRIEF DESCRIPTION OF THE DRAWINGS

Exemplary embodiments of the present invention will be understood in more detail from the following descriptions taken in conjunction with the attached drawings, in which:

FIG. 1 is a circuit diagram of a conventional internal supply-voltage generator;

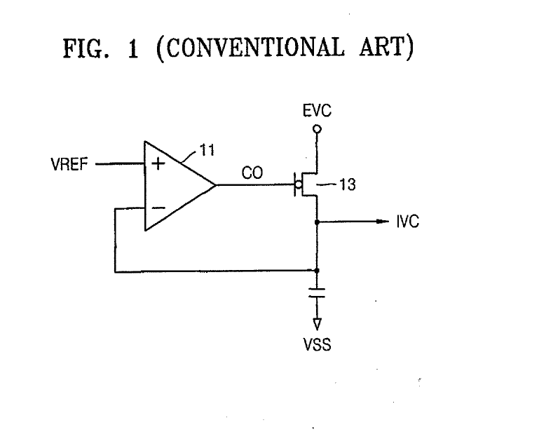

FIG. 2 is a circuit diagram of a conventional internal supply-voltage generator that can be used both in a normal operation mode and in a high-voltage test mode;

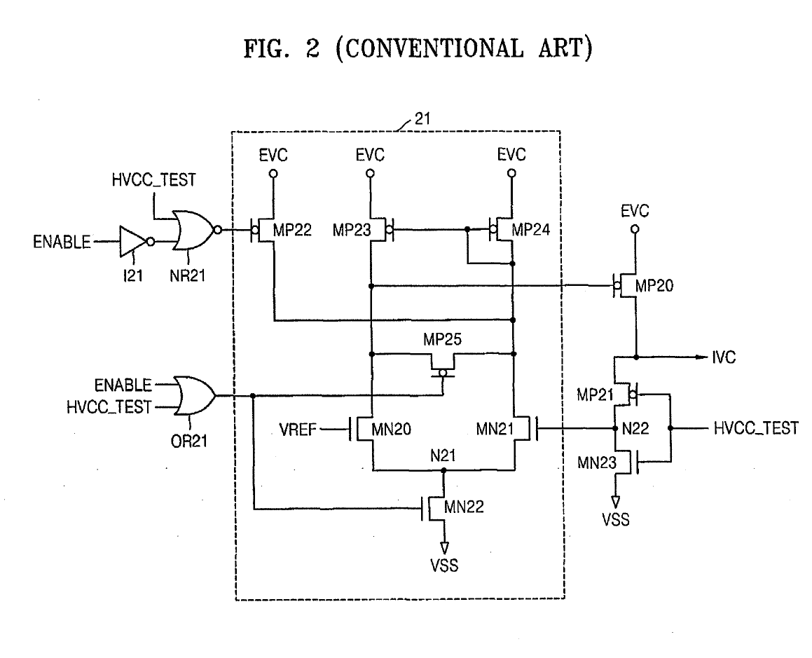

FIG. 3 is a circuit diagram of an internal supply-voltage generator according to an exemplary embodiment of the present invention;

FIG. 4 is a circuit diagram of an internal supply-voltage generator according to an exemplary embodiment of the present invention; and

FIG. 5 is a circuit diagram of an internal supply-voltage generator according to an exemplary embodiment of the present invention.

### DETAILED DESCRIPTION OF EXEMPLARY EMBODIMENTS

The attached drawings illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

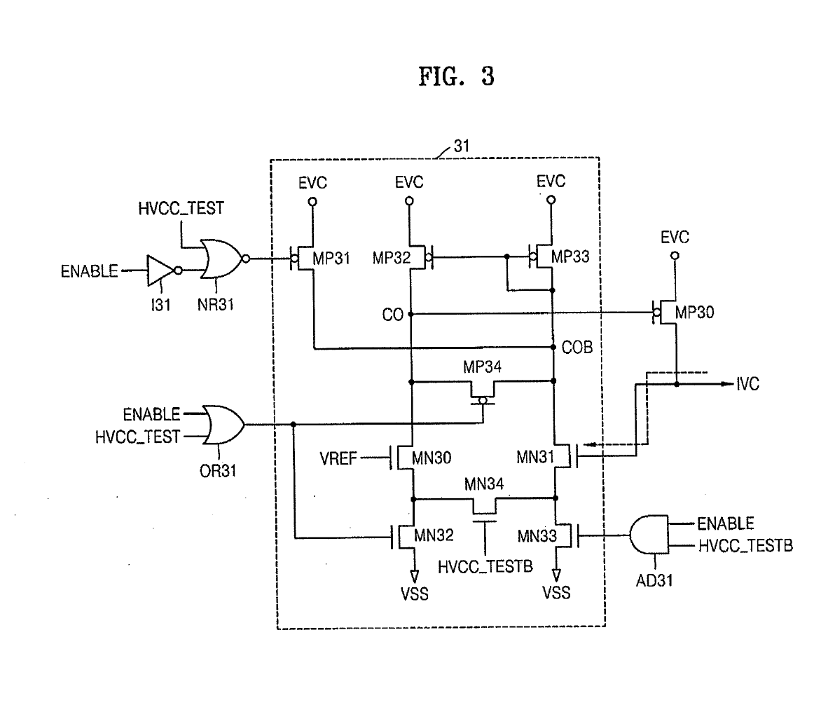

FIG. 3 is a circuit diagram of an internal supply-voltage generator according to an exemplary embodiment of the present invention.

Referring to FIG. 3, the internal supply-voltage generator includes a comparator 31, a driver MP30, and a NOR gate NR31, an inverter I31, an OR gate OR31, and an AND gate AD31 for controlling a high-voltage test.

More specifically, an internal supply voltage IVC is directly fed back to the comparator 31 and is not fed back via any transistor. The comparator 31 compares the internal supply voltage IVC that is directly fed back, with a reference voltage VREF, and outputs the result of the comparison through an output terminal CO. The driver MP30 receives an external supply voltage EVC, and outputs an internal supply voltage IVC in response to the result of the comparison received from the output terminal CO of the comparator 31.

More specifically, the comparator 31 includes a first PMOS load transistor MP32, a second PMOS load transistor MP33, a first NMOS input transistor MN30, a second NMOS input transistor MN31, a first PMOS control transistor MP34, a second NMOS control transistor MN34, a first NMOS pull-down transistor MN32, a second NMOS pull-down transistor MN33, and a pull-up transistor MP31.

The first PMOS load transistor MP32 has a source to which the external supply voltage EVC is applied, a drain connected to the output terminal CO, and a gate connected to a complementary output terminal COB. The second PMOS transistor MP33 has a source to which the external supply voltage EVC is applied, and a drain and a gate connected to the complementary output terminal COB.

The first NMOS input transistor MN30 has a drain connected to the output terminal CO, and a gate to which the reference voltage VREF is applied. The second NMOS input transistor MN31 has a drain connected to the complementary output terminal COB, and a gate to which the internal supply voltage IVC is directly fed back.

The first PMOS control transistor MP34 is connected between the output terminal CO and the complementary output terminal COB, and has a gate to which the output of the OR gate OR31 is applied. The OR gate OR31 receives a high-voltage test control signal HVCC_TEST and an internal supply-voltage generator enable signal ENABLE. The high-voltage test control signal HVCC_TEST goes logic “high” when the corresponding semiconductor memory device is in a high-voltage test mode, and the enable signal ENABLE goes logic “high” when the internal supply-voltage generator is enabled.

The second NMOS control transistor MN34 is connected between the source of the first NMOS input transistor MN30 and the source of the second NMOS input transistor MN31, and has a gate to which an inverted signal HVCC_TESTB of the high-voltage test control signal HVCC_TEST is applied.

The first NMOS pull-down transistor MN32 has a drain connected to the source of the first NMOS input transistor MN30, a gate to which the output of the OR gate OR31 is applied, and a source to which a ground voltage VSS is applied. The second NMOS pull-down transistor MN33 has a drain connected to the source of the second NMOS input transistor MN31, a gate to which the output of the NAND gate AD31 is applied, and a source to which the ground voltage VSS is applied. The NAND gate AD31 receives the inverted signal HVCC_TESTB of the high-voltage test control signal HVCC_TEST, and the internal supply-voltage generator enable signal ENABLE.

The pull-up transistor MP31 has a source to which the external supply voltage EVC is applied, a gate to which the output of the NOR gate NR31 is applied, and a drain connected to the complementary output terminal COB. The NOR gate NR31 receives the high-voltage test control signal HVCC_TEST and the output signal of the inverter I31. The inverter I31 inverts the enable signal ENABLE.

Hereinafter, the operation of the internal supply-voltage generator according to the exemplary embodiment, as illustrated in FIG. 3, witl be described in detail. When the semiconductor memory device is in a normal operation mode, the high-voltage test control signal HVCC_TEST goes logic “low” and the inverted signal HVCC_TESTB of the high-voltage test control signal HVCC_TEST goes logic “high”, so that the internal supply-voltage generator enable signal ENABLE goes logic “high”.

Accordingly, the pull-up transistor MP31 is turned off, the first PMOS control transistor MP34 is turned off, the second NMOS control transistor MN34 is turned on, and the first and second NMOS pull-down transistors MN32 and MN33 are turned on.

Accordingly, when the semiconductor memory device is in the normal operation mode, the comparator 31 operates normally by the first PMOS load transistor MP32, the second PMOS load transistor MP33, the first NMOS input transistor MN30, and the second NMOS input transistor MN31.

Meanwhile, when the semiconductor memory device is in the high-voltage test mode, the high-voltage test control signal HVCC_TEST goes logic “high”, and the inverted signal HVCC_TESTB of the high-voltage test control signal HVCC_TEST goes logic “low”, so that the internal supply-voltage generator enable signal ENABLE goes logic “low”.

Accordingly, the pull-up transistor MP31 is turned on, the first PMOS control transistor MP34 is turned off, the second NMOS control transistor MN34 is turned off, the first NMOS pull-down transistor MN32 is turned on, and the second NMOS pull-down transistor MN33 is turned off. Accordingly, the voltage of the complementary output terminal COB is fixed at the external supply voltage EVC and, as a result, the first PMOS load transistor MP32 and the second PMOS load transistor MP33 are turned off.

Accordingly, when the semiconductor memory device is in the high-voltage test mode, the output terminal CO is electrically disconnected from the operating supply voltage, that is, the external supply voltage EVC, of the comparator 31, and the voltage of the output terminal CO substantially becomes the ground voltage VSS through the first NMOS input transistor MN30 and the first NMOS pull-down transistor MN32. Therefore, the PMOS driver MP30 is fully turned on, so that the internal supply voltage IVC substantially becomes the external supply voltage EVC.

As described above, the internal supply-voltage generator according to this exemplary embodiment outputs an internal supply voltage IVC having the same level as the external supply voltage EVC, when the semiconductor memory device is in the high-voltage test mode. Also, when the semiconductor memory device is in the normal operation mode, because the internal supply voltage IVC is directy fed back to the comparator 31 not via any transistor, a constant response speed is maintained.

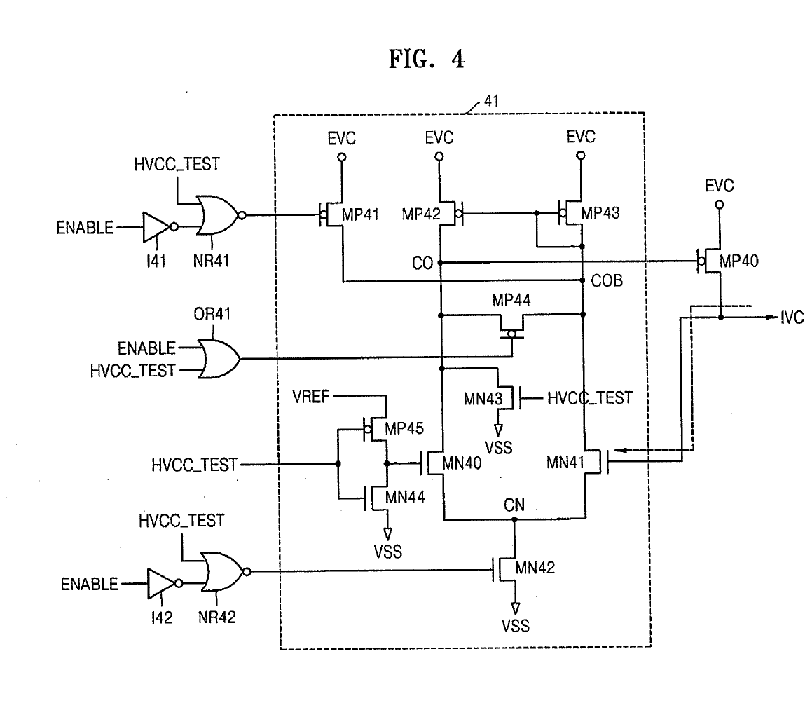

FIG. 4 is a circuit diagram of an internal supply voltage generator according to an exemplary embodiment of the present invention.

Referring to FIG. 4, the internal supply-voltage generator according to the exemplary embodiment includes a comparator 41, a driver MP40, a NOR gate NR41, an inverter I41. an OR gate OR41, a NOR gate NR42, and an inverter I42 for controlling a high-voltage test.

More specifically, an internal supply voltage IVC is directly fed back to the comparator 41, and not via any transistor. The construction of the internal supply-voltage generator according to this exemplary embodiment is similar to the construction of the internal supply voltage generator according to the exemplary embodiment shown in FIG. 3, except for the construction of the comparator 41.

The comparator 41 includes a first PMOS load transistor MP42, a second PMOS load transistor MP43, a first NMOS input transistor MN40, a second NMOS input transistor MN41, a first PMOS control transistor MP44, a second PMOS control transistor MP45, a third NMOS control transistor MN43, a fourth NMOS control transistor MN44, a NMOS pull-down transistor MN42, and a pull-up transistor MP41.

The first PMOS load transistor MP42 has a source to which an external supply voltage EVC is applied, a drain connected to an output terminal CO, and a gate connected to a complementary output terminal COB. The second PMOS load transistor MP43 has a source to which the external supply voltage EVC is applied, and a drain and a gate connected to the complementary output terminal COB,

The first NMOS input transistor MN40 has a drain connected to the output terminal CO, a source connected to a common node CN, and a gate connected to the drain of the second PMOS control transistor MP45 and the drain of the fourth NMOS control transistor MN44. A reference voltage VREF is applied to the source of the second PMOS control transistor MP45 and a high-voltage test control signal HVCC_TEST is applied to the gate of the second PMOS control transistor MP45. A ground voltage VSS is applied to the source of the fourth NMOS control transistor MN44, and a high-voltage test control signal HVCC_TEST is applied to the gate of the fourth NMOS control transistor MN44.

The first PMOS control transistor MP44 is connected between the output terminal CO and the complementary output terminal COB, and the output of the OR gate OR41 is applied to the gate of the first PMOS control transistor MP44. The OR gate OR41 receives the high voltage test control signal HVCC_TEST and an internal supply voltage generator enable signal ENABLE. The third NMOS control transistor MN43 has a drain connected to the output terminal CO, a gate to which the high voltage test control signal HVCC_TEST is applied, and a source to which the ground voltage VSS is applied.

The second NMOS input transistor MN41 has a drain connected to the complementary output terminal COB, a gate to which an internal supply voltage IVC is directly fed, and a source connected to the common node CN. The NMOS pull-down transistor MN42 has a drain connected to the common node CN, a gate to which the output of the NOR gate NR42 is applied, and a source to which the ground voltage VSS is applied. The NOR gate NR42 receives the high-voltage test control signal HVCC_TEST and the output signal of the inverter I42. The inverter I42 inverts the enable signal ENABLE.

The pull-up transistor MP41 has a source to which the external supply voltage EVC is applied, a gate to which the output of the NOR gate NR41 is applied, and a drain connected to the complementary output terminal COB. The NOR gate NR41 receives the high-voltage test control signal HVCC_TEST and the output signal of the inverter I41. The inverter I41 inverts the enable signal ENABLE.

Hereinafter, the operation of the internal supply-voltage generator according to this exemplary embodiment will be described in detail. First, when the semiconductor memory device is in the normal operation mode, the high-voltage test control signal HVCC_TEST goes logic “low”, and the internal supply-voltage generator enable signal ENABLE goes logic “high”.

Accordingly, the pull-up transistor MP41 is turned off, the first PMOS control transistor MP44 is turned off, the third NMOS control transistor MN43 is turned off, and the NMOS pull-down transistor MN42 is turned on. Also, the second PMOS control transistor MP45 is turned on and the fourth NMOS control transistor MN44 is turned off, so that a reference voltage VREF is applied to the gate of the first NMOS input transistor MN40.

Therefore, when the semiconductor memory device is in the normal operation mode, the comparator 41 operates normally by the first PMOS load transistor MP42, the second PMOS load transistor MP43, the first NMOS input transistor MN4O, and the second NMOS input transistor MN41.

On the other hand, if the semiconductor memory device is in the high-voltage test mode, the high-voltage test control signal HVCC_TEST goes logic “high”, and the internal supply-voltage generator enable signal ENABLE goes logic “low”.

Accordingly, the pull-up transistor MP41 is turned on, the first PMOS control transistor MP44 is turned off, the third NMOS control transistor MN43 is turned on, and the NMOS pull-down transistor MN42 is turned off. Also, the second PMOS control transistor MP45 is turned off. and the fourth NMOS control transistor MN44 is turned on, so that the ground voltage VSS is applied to the gate of the first NMOS input transistor MN40 and the first NMOS input transistor MN40 is turned off. Thus, the voltage of the complementary output terminal COB is fixed at the external supply voltage EVC, and as a result the first PMOS load transistor MP42 and the second PMOS load transistor MP43 are turned off.

Therefore, when the semiconductor memory device is in the high-voltage test mode, the voltage of the output terminal CO is electrically disconnected from the operating supply voltage, that is, the external supply voltage EVC, of the comparator 41, and becomes substantially the ground voltage VSS by action of the third NMOS control transistor MN43, which is turned on. Accordingly, the PMOS driver MP40 is fully turned on, and the internal supply voltage IVC becomes substantially the same as the external supply voltage EVC.

As described above, in the internal supply-voltage generator according to the exemplary embodiment shown in FIG. 4, like the internal supply-voltage generator according to the exemplary embodiment shown in FIG. 3, an internal supply voltage IVC having the same level as an external supply voltage EVC is output in the high-voltage test mode, and the internal supply voltage IVC is directly fed back to the comparator 41 and is not fed back via any transistor in the normal operation mode, so that a constant response speed is maintained.

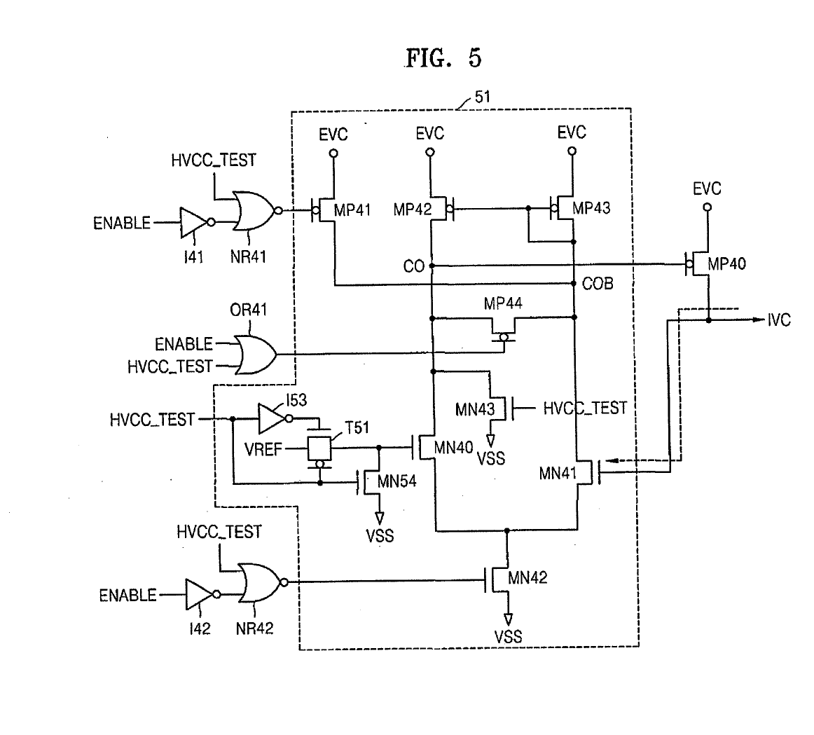

FIG. 5 is a circuit diagram of an internal supply-voltage generator according to an exemplary embodiment of the present invention.

Referring to FIG. 5, the internal supply-voltage generator according to this exemplary embodiment has a construction similar to the internal supply-voltage generator according to the exemplary embodiment as illustrated in FIG. 4, except that the drain of an NMOS transistor MN54 is connected to the gate of a first NMOS input transistor MN40 and one end of a transmission gate T51.

A high-voltage test control signal HVCC_TEST is applied to the gate of the NMOS control transistor MN54, and a ground voltage VSS is applied to the source of the NMOS control transistor MN54. A reference voltage VREF is applied to the other end of the transmission gate T51, and the transmission gate T51 is turned on when the high-voltage test control signal HVCC_TEST goes logic “low”.

The operation of the internal supply-voltage generator according to this exemplary embodiment is similar to the operation of the internal supply-voltage generator according to the exemplary embodiment as illustrated in FIG. 4 and, accordingly, a detailed description thereof will be omitted.

As described above, in an internal supply-voltage generator according to exemplary embodiments of the present invention, an internal supply voltage having the same level as an external supply voltage is output in a high-voltage test mode, and the internal supply voltage is directly fed back to a comparator and is not fed back via any transistor in a normal operation mode, so that a constant response speed is maintained.

While the present invention has been particularly shown and described with reference to exemplary embodiments thereof, it witl be understood by those of ordinary skill in the art that various changes in form and details may be made therein without departing from the spirit and scope of the present invention, as defined by the following claims.

What is claimed is:

1. An internal supply-voltage generator of a semiconductor memory device comprising:
a comparator comparing a reference voltage with an internal supply voltage and outputting a result of the comparison through an output terminal; and
a driver receiving an external supply voltage and outputting the internal supply voltage in response to the result of the comparison,
wherein the internal supply voltage is directly fed back to the comparator and the output terminal of the comparator is electrically disconnected from an operating voltage source of the comparator when the semiconductor memory device is in a high-voltage test mode.

2. The internal supply-voltage generator of claim 1, wherein the comparator comprises:
a first input transistor having one end connected to the output terminal and a gate to which the reference voltage is applied;
a second input transistor having one end connected to a complementary output terminal of the output terminal and a gate to which the internal supply voltage is applied; and
a control transistor connected between the other end of the first input transistor and the other end of the second input transistor,
wherein when the semiconductor memory device is in a normal operation mode, the control transistor is turned on so that the comparator operates normally, and when the semiconductor memory device is in the high-voltage test mode, the control transistor is turned off so that the output terminal is electrically disconnected from the operating voltage source of the comparator.

3. The internal supply-voltage generator of claim 2, wherein the comparator further comprises:
a load circuit, to which the external supply voltage is applied, and being connected to the complementary output terminal of the output terminal;
a first pull-down transistor connected between the other end of the first input transistor and a ground voltage, and being turned on both in the high-voltage test mode and in the normal operation mode;
a second pull-down transistor connected between the other end of the second input transistor and the ground voltage, being turned off in the high-voltage test mode, and being turned on in the normal operation mode; and
a pull-up transistor connected between the external supply voltage and the complementary output terminal, being turned on in the high-voltage test mode, and being turned off in the normal operation mode.

4. The internal supply-voltage generator of claim 1, wherein the comparator comprises:
a first input transistor having one end connected to the output terminal, and the other end connected to a common node; and
a second input transistor having one end connected to the complementary output terminal of the output terminal, a gate to which the internal supply voltage is applied, and the other end connected to the common node,
wherein, when the semiconductor memory device is in the normal operation mode, the reference voltage is applied to the gate of the first input transistor so that the comparator operates normally, and, when the semiconductor memory device is in the high-voltage test mode, the first input transistor is turned off so that the output terminal is electrically disconnected from the operating voltage source of the comparator.

5. The internal supply-voltage generator of claim 4, wherein the comparator further comprises:
a load circuit, to which the external supply voltage is applied, and being connected to the output terminal and to a complementary output terminal of the output terminal;
a first pull-down transistor having one end connected to the common node and the other end connected to the ground voltage, and being turned off in the high-voltage test mode and turned on in the normal operation mode;
a second pull-down transistor having one end connected to the output terminal and the other end connected to the ground voltage, and being turned on in the high-voltage test mode and turned off in the normal operation mode; and
a pull-up transistor connected between the external supply voltage and the complementary output terminal, and being turned on in the high-voltage test mode and turned off in the normal operation mode.
